(19) United States
(12) Patent Application Publication
(10) Pub. No.: US 2016/0342542 A1
(43) Pub. Date: Nov. 24, 2016

(54) DELAY DESTAGE OF DATA BASED ON SYNC COMMAND

(71) Applicant: HEWLETT PACKARD ENTERPRISE DEVELOPMENT LP, Houston, TX (US)

(72) Inventor: Douglas L Voigt, Boise, ID (US)

(21) Appl. No.: 15/114,527

(22) PCT Filed: Feb. 28, 2014
(86) PCT No.: PCT/US2014/019598

§ 371 Date: Jul. 27, 2016

(51) Int. Cl. G06F 13/16; G06F 12/0891; G06F 9/30; G06F 3/06

(52) U.S. Cl. CPC G06F 13/1689; G06F 3/0611; G06F 3/0659; G06F 3/067; G06F 12/0891; G06F 9/30043; G06F 2212/60

(57) ABSTRACT

A remote storage device may be memory mapped to a local nonvolatile memory (NVM). A sync command associated with the memory map may be received. Data may be selectively destaged from the local NVM to the remote storage device based on a type of the sync command and/or a state of the memory map.

### BACKGROUND

Due to recent latency improvements in non-volatile memory (NVM) technology, such technology is being integrated into data systems. Servers of the data systems may seek to write data to or read data from the NVM technology. Users, such as administrators and/or vendors, may be challenged to integrate such technology into systems to provide lower latency.

### BRIEF DESCRIPTION OF THE DRAWINGS

The following detailed description references the drawings, wherein:

FIG. 1 is an example block diagram of a driver device to delay destaging of data based on a type of sync command;

FIG. 2 is another example block diagram of a driver device to delay destaging of data based on a type of sync command;

FIG. 3 is an example block diagram of a memory mapping system including the driver device of FIG. 2;

FIG. 4 is an example block diagram of a computing device including instructions for delaying destaging of data based on a type of sync command; and

FIG. 5 is an example flowchart of a method for delaying destaging of data based on a type of sync command.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

When using new memory-speed non-volatile memory (NVM) technologies (such as Memristor-based, Spin-Torque transfer, and Phase Change memory), low latency may enabled through memory mapping which requires that applications be modified to synchronize or flush writes to NVM, or use appropriate libraries that do so. For legacy compatibility reasons, and due to scalability limitations of memory interconnects, block emulation on top of NVM may be common. Therefore, some storage presented to an application as block devices may be directly memory mapped, while other block devices may need to be memory mapped using the legacy approach of allocating volatile memory and synchronizing to either block storage or NVM that is too distant to access directly.

Current memory mapped storage implementations may use volatile memory (VM) to allow data that has a permanent location on block storage to be manipulated in memory and then written back to disk using a sync command. Direct memory mapping of NVM and block emulation backed by NV may also be carried out.

Examples may provide a third approach in which local NVM is used to memory map a remote storage device that cannot be directly memory mapped. A sync operation associated with a memory map may be modified, which allow writes to the remote storage device to be delayed in a controlled manner. This may include an option to distinguish syncs that can be deferred from those that should be written immediately.

An example driver device may include a mapping interface and a sync interface. The mapping interface may memory map a remote storage device to a local nonvolatile memory (NVM). The local NVM may be directly accessible as memory via load and store instructions of a processor. The sync interface may receive a sync command associated with the memory map. The sync interface may selectively destage data from the local NVM to the remote storage device based on a type of the sync command and/or a state of the memory map.

Thus, examples may allow for data to become persistent sooner than it would if remote NVM or block accessed devices were memory mapped in the traditional manner. Unlike legacy memory mapping, the sync command does not always need to send data to the remote device before completion of the sync. Examples may allow for the writing of data to the remote device may be delayed. Data which is required to reach shared remote storage before a specific time may be identified, both locally and remotely, in the course of the sync operation. Memory-to-memory accesses may be used for higher performance when the remote device is also a NVM.

When the remote storage device is not shared, transmission may take place in the background and should complete before unmap. In this mode, the sync command may flush processor caches to the local NVM but not destage data to the remote storage device. Examples may allow for memory mapped data to be persistent locally before writing it to remote storage or NVM where it will permanently reside. Examples may also determine when data is to be written to a shared remote location to insure visibility to consumers elsewhere in a system. In addition, remote storage services can be notified of consistent states attained as a result of this determination.

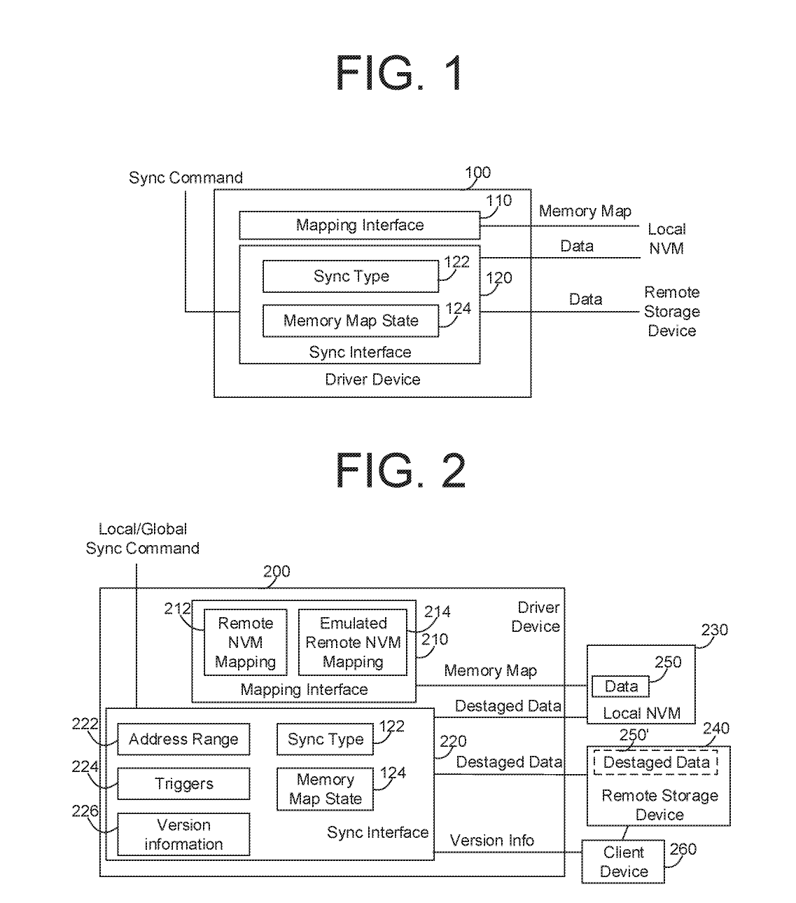

Referring now to the drawings. FIG. 1 is an example block diagram of a driver device 100 to delay destaging of data based on a type of sync command. The driver device 100 may include any type of device to interface and/or map a storage device and/or memory, such as a controller, a driver, and the like. The driver device 100 is shown to include a mapping interface 110 and a sync interface 120. The mapping and sync interfaces 110 and 120 may include, for example, a hardware device including electronic circuitry for implementing the functionality described below, such as control logic and/or memory. In addition or as an alternative, the mapping and sync interfaces 110 and 120 may be implemented as a series of instructions encoded on a machine-readable storage medium and executable by a processor.

The mapping interface 110 may memory map a remote storage device to a local nonvolatile memory (NVM). The local NVM may be directly accessible as memory via load and store instructions of a processor (not shown). The sync interface 120 may receive a sync command associated with the memory map. The sync interface 120 may selectively destage data from the local NVM to the remote storage device based on at least one of a type of the sync command 122 and a state of the memory map 124. The term memory mapping may refer to a technique for incorporating one or more memory addresses of a device, such as a remote storage device, into an address table of another device, such as a local NVM of a main device. The term destage may refer to moving data, from a first storage area, such as the local NVM or a cache, to a second storage area, such as the remote storage device.

FIG. 2 is another example block diagram of a driver device 200 to delay destaging of data based on a type of sync command. The driver device 200 may include any type of device to interface and/or map a storage device and/or memory, such as a controller, a driver, and the like. Further, the driver device 200 of FIG. 2 may include at least the functionality and/or hardware of the driver device 100 of FIG. 1. For instance, the driver device 200 is shown to include a mapping interface 210 that includes at least the functionality and/or hardware of the mapping interface 110 of FIG. 1 and a sync interface 220 that includes at least the functionality and/or hardware of the sync interface 120 of FIG. 1.

Applications, file systems, object stores and/or a map-able block agent (not shown) may interact with the various interfaces of the driver device 200, such as through the sync interface 220 and/or the mapping interface 220. The main device may be, for example, a server, a secure microprocessor, a notebook computer, a desktop computer, an all-in-one system, a network device, a controller, and the like.

The driver device 200 is shown to interface with the local NVM 230, the remote storage device 250 and a client device 260. The remote storage device 240 may not be directly accessible as memory via the load and store instructions of the processor of the main device. The main device, such as a server, may include the driver device 200. The sync command may indicate a local sync or a global sync. Further, the sync command may be transmitted by a component or software of the main device, such as an application, file system or object store.

The sync interface 220 may begin destaging the data 250 from the local NVM 230 to the remote storage device 240 in response to the global sync. However, the sync interface 220 may delay destaging the data 250 from the local NVM 230 to the remote storage device 240 in response to the local sync. The sync interface 220 may flush local cached data, such as from a cache (not shown) of the processor of the main device, to the local NVM 230 in response to either of the local and global sync commands. Moreover, the sync interface 220 may flush the local cached data to the local NVM 230 before the data 250 is destaged from the local NVM 230 to the remote storage device 240.

The sync interface 220 may record an address range 222 associated with the data 250 at the local NVM 230 that has not yet been destaged to the remote storage device 240. In addition, the sync interface 220 may destage the data 250 associated with the recorded address range 222 from the local NVM 230 to the remote storage device 240 independently of the sync command based on at least one of a plurality of triggers 224. For example, the sync interface 220 may destage the data 250′ to the remote storage device 240 prior to even receiving the sync command, if one the triggers 224 is initiated. The memory map state 124 may relate to information used to determine if at least one of the triggers 224 is to be initiated, as explained below.

In one example, a background trigger of the plurality of triggers 224 may be initiated to destage the data 250 as a background process based on an amount of available resources of the main device. The background trigger may be initiated if at least one of the remote storage device 240 is not shared with another client device 260 and the destaging of the data 250 is to be to completed before an unmap.

In another example, an unmap trigger of the plurality of triggers 224 may be initiated to destage the data 250 if a file associated with the data is to be at least one of unmapped and closed. A timer trigger of the plurality of triggers 224 may be initiated to destage the data 250 if a time period since a prior destaging of the data 250 exceeds a threshold. The threshold may be determined based on user preferences, hardware specification, usage patterns, and the like.

A dirty trigger of the plurality of triggers 224 may be initiated to destage the data 250 before the data 250 is overwritten at the local NVM 230, if the data 250 has not yet been destaged despite being modified or new. However, the sync interface 220 may not destage the data 250 at the local NVM 230 to the remote storage device 240 in response to the sync command, if the data associated with the sync command is not dirty. A capacity trigger of the plurality of triggers 224 may be initiated to destage the data 250 if the local NVM 230 is reaching storage capacity.

The sync interface 220 may transmit version information 226 to a client device 260 sharing the remote storage device 240 in response to the global sync. The version information 226 may be updated in response the global sync. The version information 226 may include, for example, a monotonically incremented number and/or a timestamp. The client device 260 may determine if the data 250′ at the remote storage device 240 is consistent or current based on the version information 226. The driver device 200 may determine if the remote storage device 240 is shared (and therefore send the version information 226) based on at least one of management and application information sent during a memory mapping operation by the main device.

The mapping interface 210 may use a remote NVM mapping 212 or an emulated remote NVM mapping 214 at the local NVM device 230 in order to memory map to the remote storage device 240. For instance, the remote NVM mapping 212 may be used for when the remote storage device 240 only has block access, such as for an SSD or HDD or because memory-to-memory remote direct memory access (RDMA) is not supported. The emulated remote NVM mapping 214 may be used for when the remote storage device 240 can only be accessed as an emulated block because it is not low latency enough for direct load/store access hut does support memory-to-memory RDMA. Hence, the mapping interface 210 may to use the emulated remote NVM mapping 214 if a latency of the remote storage device exceeds a threshold for at least one of direct load and store accesses. The threshold may be based on, for example, device specifications and/or user preferences.

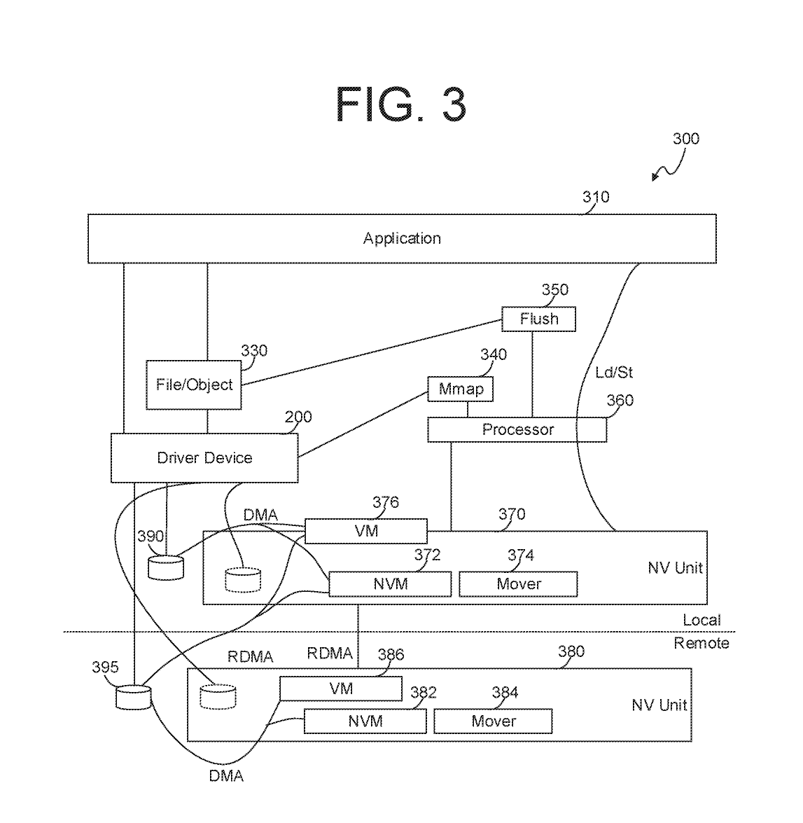

FIG. 3 is an example block diagram of a memory mapping system 300 including the driver device 200 of FIG. 2. In FIG. 3, an application 310 is shown to access storage conventionally through block or file systems, or through the driver device 200. A local NV unit 370 is shown above the dotted line and a remote NVM unit 380 is shown above the dotted line. The term remote may infer, for example, off-node or off premises. Solid cylinders 390 and 395 may represent conventional storage devices, such as a HDD or SSD, while NVM technologies may be represented as the NV units 370 and 380 containing a NVM 372 and 382 along with dotted cylinders representing block emulation,

Block emulation may be implemented entirely within the driver device 200 but backed by the NVM 372 and 382. Some of the NVM 372 and 382 may be designated “volatile,” thus VM 376 and 386 are shown to be (partially) included within the NV units 370 and 380. Movers 374 and 384 may be any type of device to manage the flow of within, to and/or from the NV units 370 and 380. The driver device 200 may memory map any storage whose block address can be ascertained through interaction with the file system or object store 330.

Here, the term NVM may refer to storage that can be accessed directly as memory (aka persistent memory) using a processor's 360 load and store instructions or similar. The driver device 200 may run in a kernel of the main device. In some systems, memory mapping may involve the driver device 200 while in other cases the driver device 200 may delegate that function, such as to the application 310, file system/object store 330 and/or the memory map unit 340. A memory sync may implemented by the agent 420. However, if the legacy method is used, then the agent 420 may involve the drivers to accomplish I/O. The software represented here as a file system or object store 430 may be adapted to use the memory mapping capability of the driver device 200. Sync or flush operations are implemented by the block, file or object software 330 and they may involve a block storage driver to accomplish I/O.

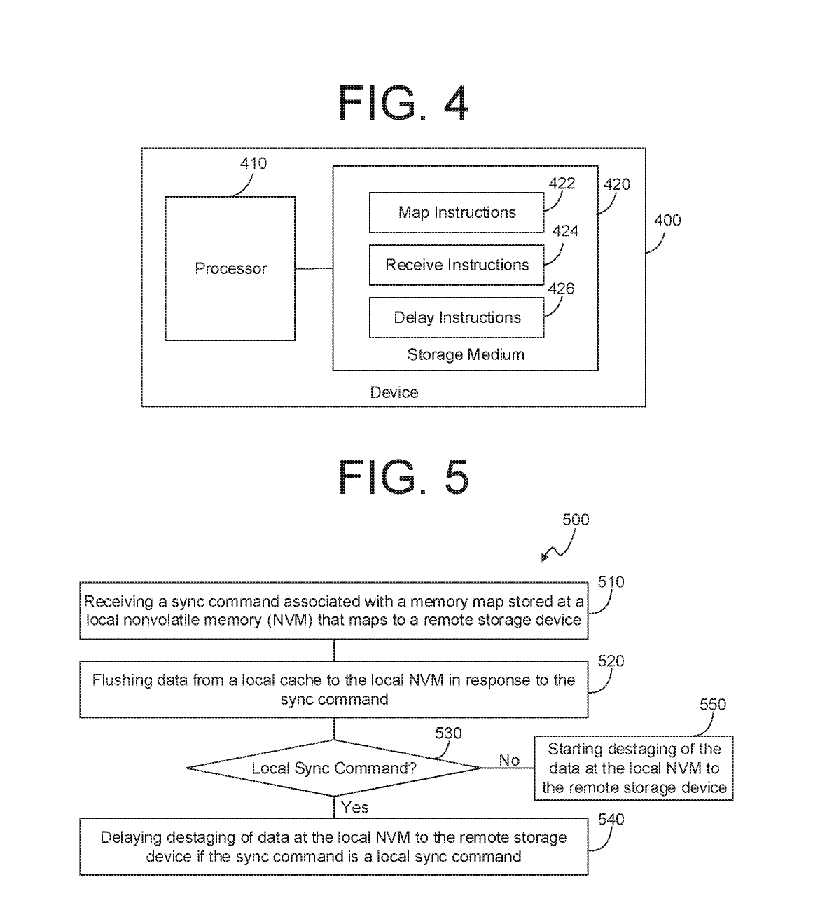

FIG. 4 is an example block diagram of a computing device 400 including instructions for delaying destaging of data based on a type of sync command. In the embodiment of FIG. 4, the computing device 400 includes a processor 410 and a machine-readable storage medium 420. The machine-readable storage medium 420 further includes instructions 422, 424 and 426 for delaying destaging of data based on a type of sync command.

The computing device 400 may be, for example, a secure microprocessor, a notebook computer, a desktop computer, an all-in-one system, a server, a network device, a controller, a wireless device, or any other type of device capable of executing the instructions 422, 424 and 426. In certain examples, the computing device 400 may include or be connected to additional components such as memories, controllers, etc.

The processor 410 may be, at least one central processing unit (CPU), at least one semiconductor-based microprocessor, at least one graphics processing unit (GPU), other hardware devices suitable for retrieval and execution of instructions stored in the machine-readable storage medium 420, or combinations thereof. The processor 410 may fetch, decode, and execute instructions 422, 424 and 426 to implement delaying destaging of the data based on the type of sync command. As an alternative or in addition to retrieving and executing instructions, the processor 410 may include at least one integrated circuit (IC), other control logic, other electronic circuits, or combinations thereof that include a number of electronic components for performing the functionality of instructions 422, 424 and 426.

The machine-readable storage medium 420 may be any electronic, magnetic, optical, or other physical storage device that contains or stores executable instructions. Thus, the machine-readable storage medium 420 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 420 can be non-transitory. As described in detail below, machine-readable storage medium 420 may be encoded with a series of executable instructions for delaying destaging of the data based on the type of sync command.

Moreover, the instructions 422, 424 and 426 when executed by a processor (e.g., via one processing element or multiple processing elements of the processor) can cause the processor to perform processes, such as, the process of FIG. 5. For example, the map instructions 422 may be executed by the processor 410 to map a remote storage device (not shown) to a local NVM (not shown). The receive instructions 424 may be executed by the processor 410 to receive a sync command associated with the memory map.

The delay instructions 426 may be executed by the processor 410 to selectively delay destaging of data at the local NVM to the remote storage device based on a type of the sync command.

FIG. 5 is an example flowchart of a method 500 for delaying destaging of data based on a type of sync command. Although execution of the method 500 is described below with reference to the driver device 200, other suitable components for execution of the method 500 may be utilized, such as the driver device 100. Additionally, the components for executing the method 500 may be spread among multiple devices (e.g., a processing device in communication with input and output devices). In certain scenarios, multiple devices acting in coordination can be considered a single device to perform the method 500. The method 500 may be implemented in the form of executable instructions stored on a machine-readable storage medium, such as storage medium 420, and/or in the form of electronic circuitry.

At block 510, the driver device 200 receives a sync command associated with a memory map stored at a local NVM 230 that maps to a remote storage device 240. Then, at block 520, the driver device 200 flushes data from a local cache to the local NVM 230 in response to the sync command. Next at block 530, the driver device 200 determines the type of the sync command 122. If the sync command is a local sync command, the method 500 flows to block 540 where the driver device 200 delays destaging of data 250 at the local NVM 230 to the remote storage device 240. However, if the sync command is a global sync command, the method 500 flow to block 550 where the driver device 200 starts destaging of the data 250 at the local NVM 230 to the remote storage device 240.

We claim:

1. A driver device, comprising:
a mapping interface to memory map a remote storage device to a local nonvolatile memory (NVM), the local NVM to be directly accessible as memory via load and store instructions of a processor; and
a sync interface to receive a sync command associated with the memory map, the sync interface to selectively destage data from the local NVM to the remote storage device based on at least one of a type of the sync command and a state of the memory map.

2. The driver device of claim 1, wherein,
the remote storage device is not directly accessible as memory via the load and store instructions of the processor, and
the sync command indicates at least one of a local sync and a global sync.

3. The driver device of claim 2, wherein,
the sync interface is to begin destaging the data from the local NVM to the remote storage device in response to the global sync, and
the sync interface is to delay destaging the data from the local NVM to the remote storage device in response to the local sync.

4. The driver device of claim 3, wherein,
the sync interface is to flush local cached data to the local NVM in response to both the local and global sync commands, and
the sync interface is to flush the local cached data to the local NVM before the data is destaged from the local NVM to the remote storage device.

5. The driver device of claim 3, wherein
the sync interface is to record an address range associated with the data at the local NVM that is not destaged to the remote storage device, and
the sync interface is to destage the data associated with the recorded address range from the local NVM to the remote storage device independently of the sync command based on at least one of a plurality of triggers.

6. The driver device of claim 5, wherein,
a background trigger of the plurality of triggers is initiated to destage the data as a background process based on an amount of available resources, and
the background trigger is initiated if at least one of the remote storage device is not shared with another client device and the destaging of the data is to be to completed before an unmap.

7. The driver device of claim 5, wherein,
an unmap trigger of the plurality of triggers is initiated to destage the data if a file associated with the data is to be at least one of unmapped and closed,
a timer trigger of the plurality of triggers is initiated to destage the data if a time period since a prior destaging of the data exceeds a threshold,
a dirty trigger of the plurality of triggers is initiated to destage the data before the data is overwritten at the local NVM, if the data is not yet destaged, and
a capacity trigger of the plurality of triggers is initiated to destage the data if the local NVM reaches storage capacity.

8. The driver device of claim 2, wherein the sync interface is to transmit version information to a client device sharing the remote storage device in response to the global sync, and
the version information is updated in response the global sync.

9. The driver device of claim 8, wherein:
the version information includes least one of an incremented number and a timestamp, and
the client device is to determine if the data at the remote storage device is consistent based on the version information.

10. The driver device of claim 1, wherein,
the mapping interface is to use at least one of a remote NVM mapping and an emulated remote NVM mapping at the local NVM device, and
the mapping interface is to use the emulated remote NVM mapped system if a latency of the remote storage device exceeds a threshold for at least one of direct load and store accesses.

11. The driver device of claim 10, wherein,
the mapping interface is to use the remote NVM mapped system if the remote storage device at least one of only supports block access and does not support memory-to-memory access, and
the mapping interface is to use the emulated remote NVM mapped system if the remote storage device at least one of only supports emulated block access and does support memory-to-memory access.

12. The driver device of claim 11, wherein,
the remote storage device of the emulated remote NVM mapped system does not support remote direct memory access (RDMA),
the remote storage device of the remote NVM mapped system does support RDMA, and
the sync command is sent by at least one of block, file and object software.

13. The driver device of claim 2, wherein,
the driver device is to determine if the remote storage device is shared based on at least one of management and application information sent during a memory mapping operation, and
the sync interface is to not destage the data at the local NVM to the remote storage device in response to the sync command, if the data associated with the sync command is not dirty.

14. A method, comprising:
receiving a sync command associated with a memory map stored at a local nonvolatile memory (NVM) that maps to a remote storage device;
flushing data from a local cache to the local NVM in response to the sync command; and
delaying destaging of data at the local NVM to the remote storage device if the sync command is a local sync command; and
starting destaging of the data at the local NVM to the remote storage device if the sync command is a global sync command.

15. A non-transitory computer-readable storage medium storing instructions that, if executed by a processor of a device, cause the processor to:
map a remote storage device to a local nonvolatile memory (NVM);
receive a sync command associated with the memory map; and
selectively delay destaging of data at the local NVM to the remote storage device based on a type of the sync command.
